(19) United States
(12) Patent Application Publication
(10) Pub. No.: US 2019/0087923 A1
(43) Pub. Date: Mar. 21, 2019

(54) SYSTEM AND METHOD FOR AUTOMATED CONTINUING EDUCATION ATTENDANCE AND CREDIT TRACKING

(71) Applicant: Expo Inc., Chicago, IL (US)

(72) Inventors: Brett Gough, South Barrington, IL (US); Doug Moring, Chicago, IL (US); Ciprian Petrini, Los Angeles, CA (US)

(21) Appl. No.: 16/135,513

(22) Filed: Sep. 19, 2018

Related U.S. Application Data
(60) Provisional application No. 62/560,494, filed on Sep. 19, 2017.
(60) Provisional application No. 62/579,701, filed on Oct. 31, 2017.

(51) Int. Cl. G06Q 50/20; G07C 1/10

(52) U.S. Cl. CPC G06Q 50/2057; G07C 1/10

(57) ABSTRACT

The present disclosure generally relates to a system and method of automated continuing education management by using various computer implemented modules such as an Continuing Education Module and an Attendance Tracking Module, all communicatively connected for seamless tracking and management of continuing education attendees, including validating and providing continuing education credits, establishing and validating qualification thresholds and creating and exporting continuing education completion certificates. More particularly, the present invention is related to a computer or machine implemented method and related system and method for carrying out an automated or machine-assisted continuing education attendance and credit tracking for various organizations and businesses.

### CROSS REFERENCE TO RELATED APPLICATIONS

The present application claims priority from U.S. Provisional Application Ser. No. 62/560,494, filed Sep. 19, 2017 and U.S. Provisional Application Ser. No. 62/579,701, filed Oct. 31, 2017 all of which is herein incorporated by reference in its entirety.

### BACKGROUND OF THE INVENTION

The present disclosure generally relates to a system and method of automated continuing education management by using various computer implemented modules such as an Continuing Education Module, an Attendance Tracking Module and Lead Retrieval Module, all communicatively connected for seamless tracking and management of continuing education attendees, including validating and providing continuing education credits, establishing and validating qualification thresholds and creating and exporting continuing education completion certificates. More particularly, the present invention is related to a computer or machine implemented method and related system and method for carrying out an automated or machine-assisted continuing education attendance and credit tracking for various organizations and businesses.

Members of professional organizations and professions typically have accreditation standards. In order to keep professionals current with industry standards, organizations often require a certain amount of continuing education courses by professional members. Organizations require an efficient management of continuing education sessions that meets requirements with simplified device agnostic processes to provide continuing education, related credits and certificate of completion to attendees of such education sessions.

Previously, the process of managing continuing education was performed manually. For example, organizers would manually document the times in and out of events either in a spreadsheet or paper. After the conclusion of an event the organizer would manually calculate whether a criterion was met. If it was met they would create and hand-sign a certificate that would be mailed through the postal service to the attendee. However, with the advancement of computing technology such management of continuing education looks highly inefficient and cumbersome. Therefore, many associations provide the practice of continuing education attendance and credit tracking in a manual and cumbersome process.

In organizations, even if automated software based attendance session tracking is utilized to simplify the management of continuing education processes, the current state leaves a cumbersome back office process for creating a continuing education session, validating the session, tracking and managing the attendees, validating qualification thresholds and providing certificates on completion of the sessions. Such processes have frustrated organizations to the point of abandoning continuing education for their employees.

### SUMMARY OF THE INVENTION

Described herein are embodiments of systems and methods for enabling automated continuing education attendance and credit tracking. These systems and method may be implemented using a variety of hardware and software systems which may interact with organizations providing such continuing education, their vendors and other applicable and/or necessary parties to improve their processes, capture available information and otherwise overcome the limitations, shortcomings and disadvantages of known systems and methods. Software operates as a set of instructions running in executable memory of a processor residing on a computing device. It is to be recognized by one of skill in the art that the terms “software,” “app,” “module,” “routine,” or “subroutine” may be used interchangeably in this specification to describe a software or component parts thereof. In some embodiments of the present invention, each described module or routine/subroutine is a component part of a larger set of software instructions while in other embodiments each described module or routine/subroutine act as independent software applications. It is also to be recognized by one of skill in the art that the term “database” as used may describe a single specific database, or a sub-section of a larger database.

In a first embodiment the system comprises a local computer or a backend cloud server and networked devices configured with a graphical user interface (GUI) and plurality of communicatively coupled software modules configured to register users and collect and store pertinent registration data, event data, attendance data, and lead data. Networked devices may include but are not limited to cell phones, handheld devices, different portable tablets, or portable computers, or additional computers.

In one aspect of system, the system includes a Continuing Education Module (CEM) that is available on or accessible through the computer or networked device. The CEM is a data collection module configured to collect information regarding a continuing education session provided by session organizers, collect registration data from session observers, and store the data in a CEM database. The CEM may also be configured as a data delivery module displaying pre-recorded or live stream presentations through the graphical user interface and a data management module configured for session observers, presenters and organizers to manage all aspects of the session and certification.

In another embodiment of the system, the system includes an Attendance Tracking Module (ATM) that is available on or accessible through a computer or networked device. The ATM is a data collection module configured to collect attendance data of a session or presentation and store the information in an accessible ATM database. In some embodiments the ATM uses physical verification and local networked devices to such as barcode/QR scanners, cameras, RFIDs, and fingerprint readers, while in in other embodiments the ATM uses virtual verification such as the entering of a password or promotion code through the graphical user interface on a networked device.

In the aforementioned embodiments, all modules may be communicatively connected for seamless tracking and management of continuing education attendees, including validating and providing continuing education credits, establishing and validating qualification thresholds and creating and exporting continuing education completion certificates.

### BRIEF DESCRIPTION OF THE DRAWINGS

The following disclosure as a whole may be best understood by reference to the provided detailed description when read in conjunction with the accompanying drawings, drawing descriptions, abstract, background, field of the disclosure, and associated headings. Identical reference numerals, when found on different figures, identify the same elements or functionally equivalent elements. The elements listed in the abstract are not referenced but nevertheless refer by association to the elements of the detailed description and associated disclosure.

FIG. 1 is an illustration of a hardware system wherein a system and method in accordance with the present invention can be implemented.

FIG. 2 is an illustration of a flow chart wherein a system and method in accordance with the present invention can be implemented.

FIG. 3 is an illustration of a flow chart of the back-office processes of the continuing education module wherein a system and method in accordance with the present invention can be implemented.

FIG. 4. is an illustration of a flow chart representing the CE Attendance Verification Process.

FIGS. 9-18 are illustrations comprising of various screenshots including creation of a continuing education session, assignment of type of continuing education, assigning credit hours, assigning qualifying threshold, tracking attendance and generating certificate of completion for an exemplary application of the automated continuing education attendance and credit tracking system.

### DETAILED DESCRIPTION OF THE PREFERRED EMBODIMENTS

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

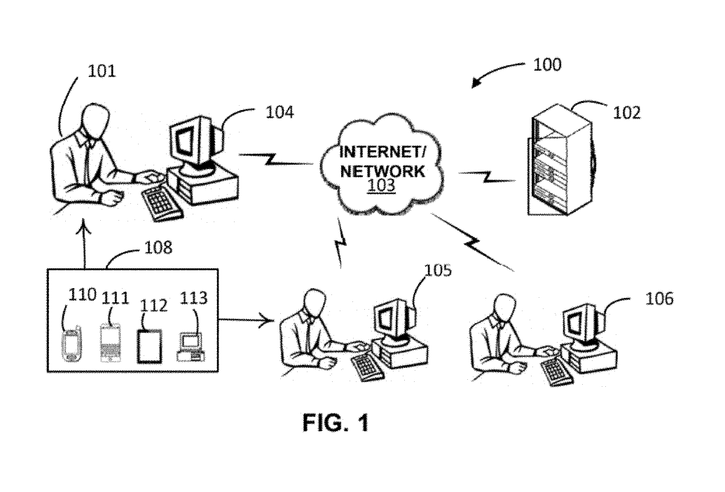

These systems and methods are supported by software operating as a set of instructions running in executable memory of a processor residing on a computing device. To fully enable the software and its functionality described herein, the present disclosure begins with a summary of how computers may be used, either alone or in a networked configuration. FIG. 1 illustrates a hardware configuration 100 wherein a system and method for managing an event online is implemented by managing attendance tracking and lead retrieval for conference attendees used by different users 101 and connected over a network 103. The network 103 is suitable for connecting the one or more computers 104, 105 and 106, or mobile devices 110, 111, 112 and 113 and may comprise one or more networks such as a local area network (LAN), a wide area network (WAN) such as the Internet, telephone networks, including telephone networks with dedicated communication links and/or wireless links, and wireless networks. In the illustrative example shown in FIG. 1, the network 103 is the Internet. Each of the one or computers 104, 105 and 106, or mobile devices 110, 111, 112 and 113 is connected to the network 103 via a suitable communication link, such as a dedicated communication line or a wireless communication link.

In an embodiment, the system may be implemented using software that is either local or operating from a remote server such as a web server or cloud server over the Internet. Further, with the rapid growth of Internet technology and portable wireless technology, other computing devices, such as, but not limited to, cell phones, handheld devices, different portable tablets, or portable computers, may be used in place of or in addition to the one or more computers.

Each of the one or more computers 104, 105 and 106, comprises a central processing unit (CPU), an input/output (I/O) unit, a display device communicatively coupled to the I/O unit, a storage device, and a memory. Each of the one or more computers 104, 105 and 106, or mobile devices 110, 111, 112 and 113 may further comprise one or more standard input devices such as a keyboard, a mouse, speech processing means, or a touchscreen.

The memory includes a Graphical User Interface (GUI) that is used to convey information to and receive information from a user of the one or more computers 104, 105 and 106, or mobile devices 110, 111, 112 and 113 via the display device and I/O unit as described herein. The GUI includes any user interface capable of being displayed on a display device including, but not limited to, a web page, a display panel in an executable program, or any other interface capable of being displayed on the one or more computers 104, 105 and 106, or mobile devices' 110, 111, 112 and 113 respective display devices.

As will be recognized by one of skill in the art, each of the cell phones 110, hand-held devices 111, different portable tablets 112, or computers 113 may be configured similarly to the one or more computers 104, 105 and 106, or mobile devices 110, 111, 112 and 113, taking into account the various design considerations of these respective devices.

The GUI may be transmitted to the one or more computers 104, 105 and 106, or mobile devices 110, 111, 112 and 113 or other devices via the network 103. In one embodiment in accordance with the present invention, the GUI is displayed using commercially available hypertext markup language (“HTML”) viewing software such as, but not limited to, MICROSOFT INTERNET EXPLORER, GOOGLE CHROME, APPLE SAFARI, OR MOZILLA FIREFOX, or any other commercially available HTML viewing software.

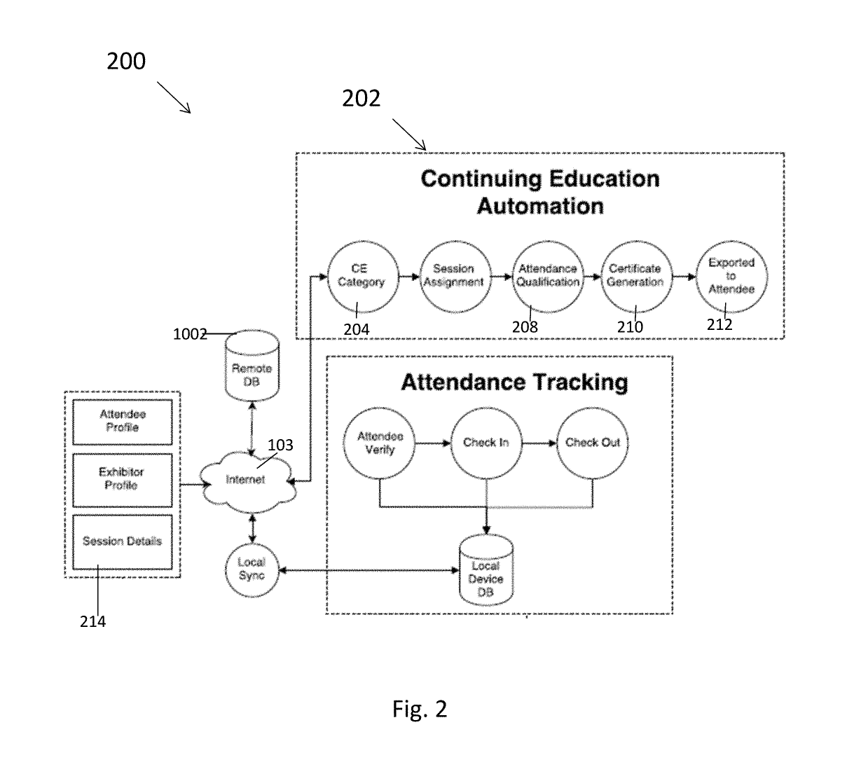

As illustrated in FIG. 2, the system 200 includes a Continuing Education Module (CEM) application 202 that is available on or accessible through a computer or networked device. The CEM 202 is a data delivery module coupled to a CEM database 1002 and configured to deliver Continuing Education session data including, but not limited to, stored sessions and live streaming events. The CEM 202 may include additional modules or subroutines such as the Attendance Qualification Module (AQM) 208 configured to qualify attendance by comparing start and end times of the session to assure the registrant attended a predetermined percentage of the session, Certificate Generation Module (CGM) 210 configured to aggregate all the data and produce a certificate of completion based on the provided template, and Export to Attendee Module (ETA) 212 configured to export a record of attendance and completion of the session to the employee. When the threshold is met from Attendee Qualification Module, the ETA 212 will automatically generate a certificate and make it available. That certificate may then be exported from the web platform, emailed to the attendee as an attachment or link, or downloaded from the mobile app. In operation, an organization can use this application and connected modules to efficiently manage the delivery of continuing education sessions.

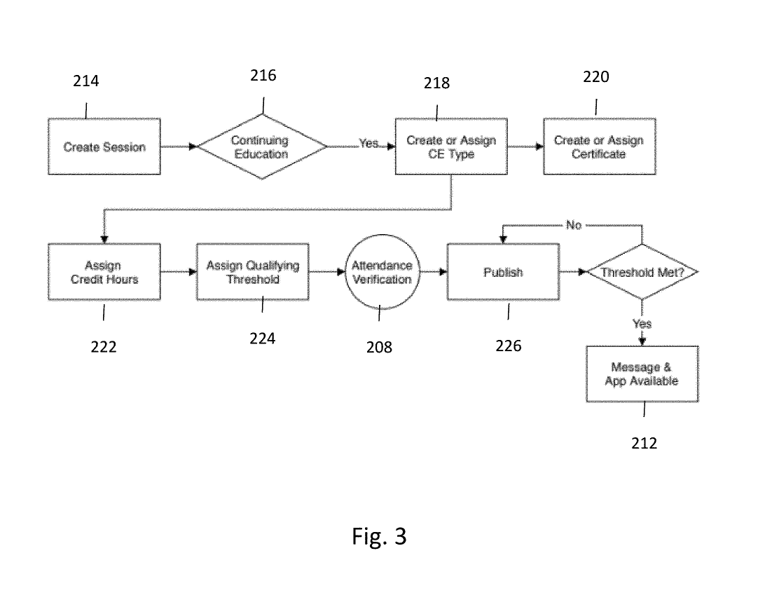

As further illustrated in FIG. 3, the CEM 202 comprises a back-office system wherein a session 214 is created for the required continuing education 216. The CEM 202 module reviews the creation of the session and its content, and may assign a CE type or category 218 and generate, assign, or create a certificate 220. Next, a predetermined number of credit hours may be assigned 222 and a qualification threshold set 224. In operation, the AQM 208, validates the attendance of the continuing education session. Once the attendee meets the qualification threshold, the CEM 202 creates and publishes 226 a completion certificate or assigns completion certificates to attendees which are then made available to attendees via the ETA-CEM module 212.

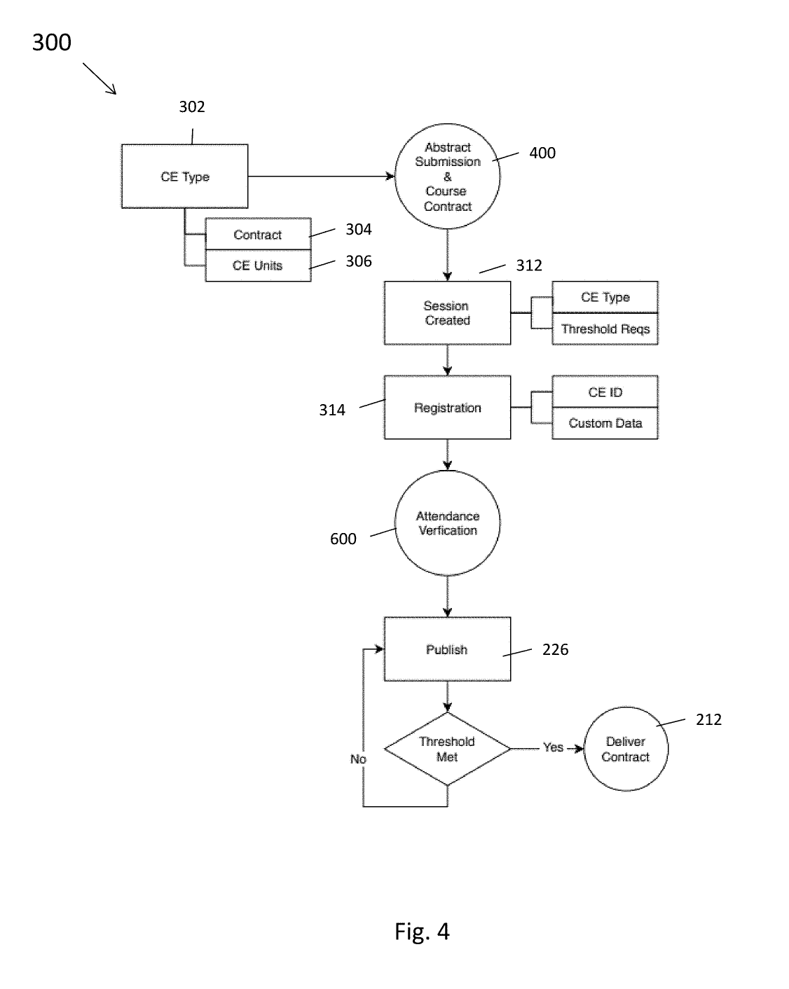

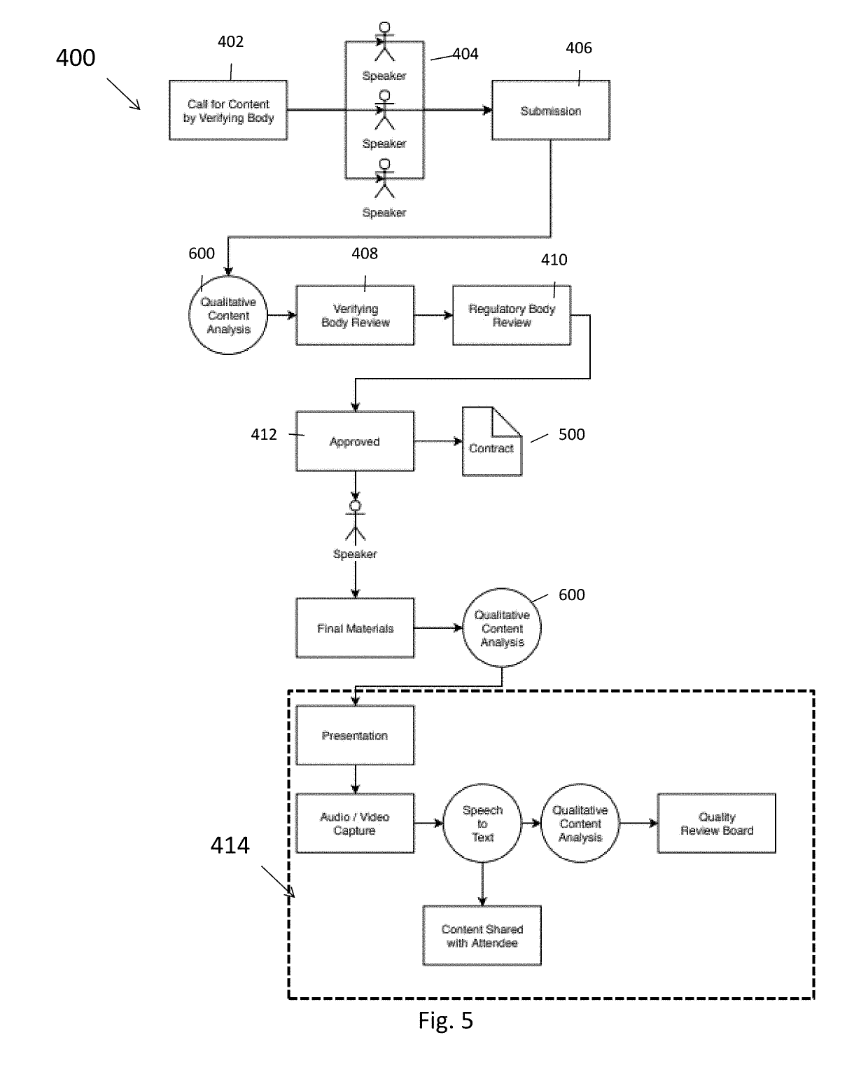

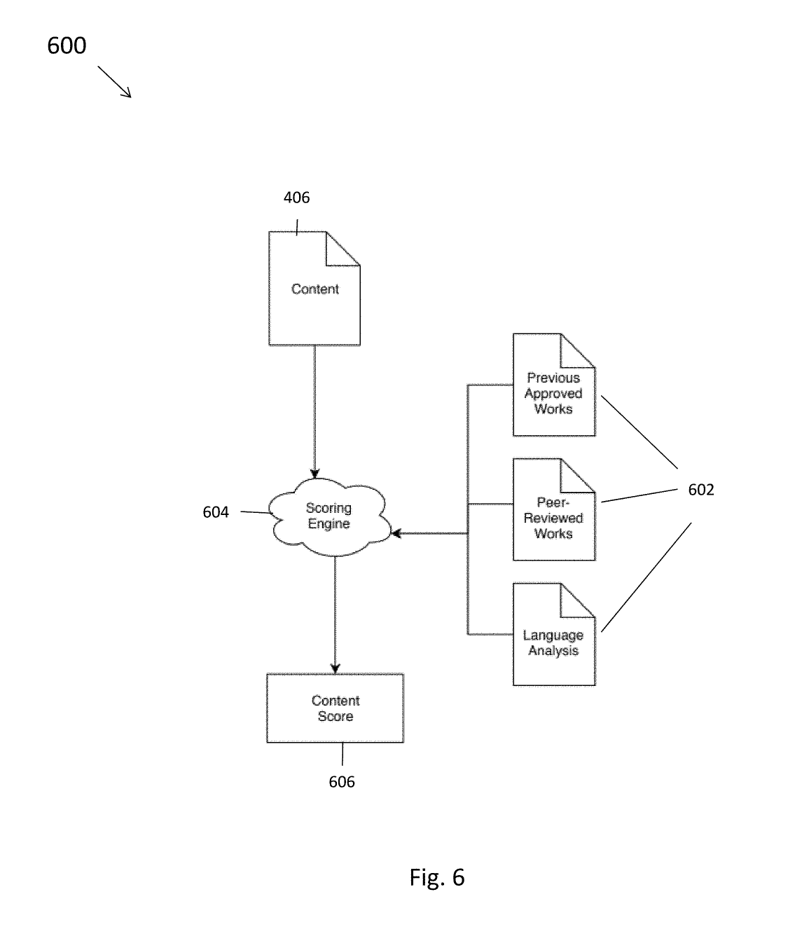

In another embodiment of the CEM 202, as outlined in the operational flow chart of FIG. 4, the CEM is configured as a data management module 300. The purpose of the CEM 202 management subroutine is to provide an end to end management of the continuing education fulfillment process. A Continuing Education (“CE”) Type 302 is created through the CEM. The CE Type 302 is a specific regulatory unit defined by the organizer. The data management module 300 may be configured to input Continuing Education session data regarding the session, including, but not limited to, entering information regarding the continuing education category, session assignment, attendance qualification, certificate generation and certificate export to the attendee. A session organizer, through the GUI, may several have access to pre-determined customized field for consideration or have the opportunity to customize information according to specific business needs. The organizer may collect data or enter data including but not limited to specific requirements in terms of sessions, to paid attendance levels, single or multi-use of promotional codes or any other items related to attending a conference or participating in an event.

With regards to FIG. 4, a CE Type 302 may comprise any of the following including but not limited to: a Contract 304, CE Units 306, an Attendance Threshold 308, and Ancillary Data 310. A Contract 304 may be defined as a document that is delivered to an attendee acknowledging the successful completion of a course. A Contract 304 or Template may comprise a digital representation which may be Digital Fingerprinting 500 or a PDF/Physical Document including letterhead, signature, and CE Type/Attendee metadata. CE Units 306 may be defined as the type of credits that are rewarded as part of the contract for the course. There can be more than one type of credit awarded to a particular CE Type 304. Attendance Threshold 308 may be defined by the percentage of time for the duration of the session that an attendee must be present. For example if a session is 60 minutes at 90% the attendee must be in session for 54 minutes. Ancillary Data 310 may be defined as metadata may be supplied to supplement any specific regulation required data for effective completion. After CE type 302 is created, the data management module 300 may initiate an abstract submission and course contract subroutine 400 configured to collect abstracts and course data through the GUI. After the abstract submission and course contract subroutine 400 is complete, the data management module 300 creates a session 312 which defined through the previously submitted data is a seminar or educational unit that may have more than one CE type of varying credit hours depending on a regulatory body's decision on its merits.

After the session is created, data management module 300 is configured to collect registration data regarding the observers of the session and their respective memberships and organizations. Registration 314 is the process of an attendee agreeing to attend a session for the purpose of receiving credit whom must provide any required data for CE approval. As relates to FIG. 4, Publish is the process of the verifying body or event organizer releasing a combined contract to an attendee who has met the required attendance threshold. In additional embodiments of the CEM 202 or sub-modules, the CEM 202 is configured as an API to be integrated on an end user's website and allow access to the data collection module accordingly. In other embodiments, the CEM 202 is configured to integrate data from third party API's to integrate user data such as a customer's GOOGLE tracking code (or similar identifying code including but not limited to FACEBOOK ID, LINKEDIN). These embodiments allow real-time updates without any code changes to the Registration form based on new information.

After registration 314, the registrant or attendee may have access to the session 312 to either physically or virtually attend. The data management module 300 or CEM 202 may initiate the Attendance Verification Module 600 configured to verify and qualify attendance of an attendee or registrant. In operation, the AQM-CEM 208 validates the attendance of the continuing education session. Once the attendee meets the qualification threshold, the CEM 202 or data management module 300 creates and publishes 226 a completion certificate or assigns completion certificates to attendees which are then made available to attendees via the ETA-CEM module 212.

As described above and shown in FIG. 4, the system 200 may comprise an abstract submission and course contract subroutine 400 as shown in the operational flow chart of FIG. 5. The abstract submission and course contract subroutine 400 is configured as a data collection module for the purpose of collecting and organizing abstract submission and overall course management. The purpose of the abstract submission and management experience is to simplify the collection of materials, automate the validation, scoring, approval, and final analysis of the experience. As shown in the operational flow chart of FIG. 5 the following functions are initiated in the subroutine: a call for content 402, a call for speakers 404, submission of initial materials 406, a quantitative content analysis 600, a verifying body review 408, a regulatory body review 410, approval 412 and the creation of digital fingerprint, an additional quantitative content analysis 700, and content capture 414. The call for content 402 and call for speakers 404 subroutines are configured to collect data for speakers through a public link through the GUI. These speakers will submit 406 their materials through a common public portal through the GUI. When these materials are received they go through a qualitative analysis 600 to score their noteworthiness. When a score is assessed it is passed along to the verifying body 408 for final review and submission to the regulatory body 410 for final approval 412. At the point where it is approved by the regulatory body 410 a contract or digital fingerprint is created. The purpose of this fingerprint is to provide assurance to the registrant that this is in fact something the registrant will get credit for if the registrant attends. Upon approval 412, notification is provided to the speaker who may then gather final materials together. These materials are then prepared for presentation 414 and are provided back through the qualitative analysis flow 700 to assure it matches original submission and is creditworthy. During the presentation of materials an audio/video recording is captured and ran back through the qualitative analysis to assure what was presented matches what was pitched for abstract.

In another embodiment of the CEM 202, as shown in FIG. 5, the system performs a qualitative content analysis as shown in the operational flow chart of FIG. 6. Traditionally, CE Legislation has dictated a quantitative requirement on continuing education without focus on qualitative analysis of the content. With thousands of CE providers across the nation the value and impact of that content varies substantially. To address this issue, the qualitative content analysis subroutine performs the steps of a digital analysis of content across the CE segment or proposed session 406 in relation to scholarly works, and peer-reviewed journals 602. The recorded CE segment is transcribed 406, and along with the abstract summary, is compared to imported scholarly works and peer-reviewed journals for key terms through the scoring engine 604 and scored 606 appropriately for qualitative content.

In yet another embodiment of the present invention, the system 200 includes an Attendee Tracking Module (ATM) 500 that is available on or accessible through a computer or networked device. The ATM 500 is a data collection module configured to collect attendance data regarding attendance of a continuing education session or presentation and store the information in an accessible ATM database. The ATM 500 may include additional modules or subroutines such as the Attendee Verification Module (AVM) 504, Attendee Check In Module (ACIM) 506 and Attendee Check Out Module (ACOM) 508.

In some embodiments, the ATM 500 is connected via a network to a local device, such as a barcode/QR code scanner, camera, fingerprint scanner, High fidelity digital location tracking based on mobile device, i.e. Beacon, Indoor Mapping, RFID, GPS or other input device, to execute the AVM 504. The AVM 504 uses the local device to identify a pre-configured hash or anonymous data within a barcode/QR code or RFID, or similar unique identifying device such as an optical scan of a driver's license or fingerprint verification to look up the individual within the CEM database. In embodiments accounting for remote or virtual attendance, a registrant may enter a password, scan a code, or use a mobile devices camera as verification. Upon finding a positive match, the ACIM 506 proceeds with changing the status of the user within the ATM database or linked CEM database to reflect attendance. In some embodiments the ACIM 506 additionally provides a time stamp to the database as well. Upon leaving the event, in some embodiments, the ATM 500 is connected via a network to a local device, such as a barcode/QR code scanner, camera, or other input device, to execute the AVM 504 and initiate the ACOM 508. Upon finding a positive match, the ACOM 508 proceeds with changing the status of the user within the ATM database or linked RM database to reflect that the user has left the event. In some embodiments the ACOM 508 additionally provides a time stamp to the database as well.

A simplified flow chart outlining the ATM 500 can be viewed in FIG. 7. The ATM 500 initiates an account authentication routine 502 which looks to input physical or virtual credentials 504 as described above, verify 506 the credentials, and authenticate and check-in/check-out 508 the attendee.

After the ACOM 508 process is complete the CEM 202 runs a validation subroutine through the AQM and ETA to validate the certificate. The validation of the certificate is based on the qualifications specified by the organizer, whereby the organizer specifies the number of hours required and the associated sessions that fulfill such requirement. In addition, the organizer can specify what percentage (%) of those hours must be met by the attendee to meet the qualifying threshold. The system would analyze these requirements and if the qualifications are met, it would generate and export a completion certificate.

In another aspect of the system 200, as outlined in the operation flow chart of FIG. 8, the recording of attendance is documented through a digital method that creates a permanent storage record in a private or public database. This record may be distributed between trusted parties and always available. Digital fingerprinting or Attendance fingerprinting 700 may be generated based on the aforementioned modules and methods described above. The records may be stored in a permanent storage form that may not easily be edited. This storage record may be part of a blockchain or distributed ledger. A certificate may be generated storing the following types of information: Identity 702, Verifying Body 704, Course Metadata 706, Valid Course Contract 708, Course Contract 710, Ledger 712, and 3^{rd} Party Query 714. Identity 702 is defined as the verified identity of the user through a method listed in the attendance verification methods. Verifying Body 704 is defined as the accredited body that is approved for verifying the attendance of an accredited individual. Course Metadata 706 is defined as data corresponding to the course including name, location, materials, etc. Valid Course Contract 708 is defined as approval from an accredited body that the course has passed review and is recognized for the accredited hours. Identity 702, Verifying Body 704, Course Metadata 706, Valid Course Contract 708 all combine in the process flow to create the Course Contract 710 defined as a complete record indicating with attached timing and affirmation of approved pieces. The course Contract 710 is then added to the Ledger 712 which is defined as an ongoing record of course contracts confirming attendance. After the contract 710 is placed on the ledger 712, a 3rd Party Query 714 is available giving the ability for a 3rd party to ask the ledger 712 for these records to confirm attendance.

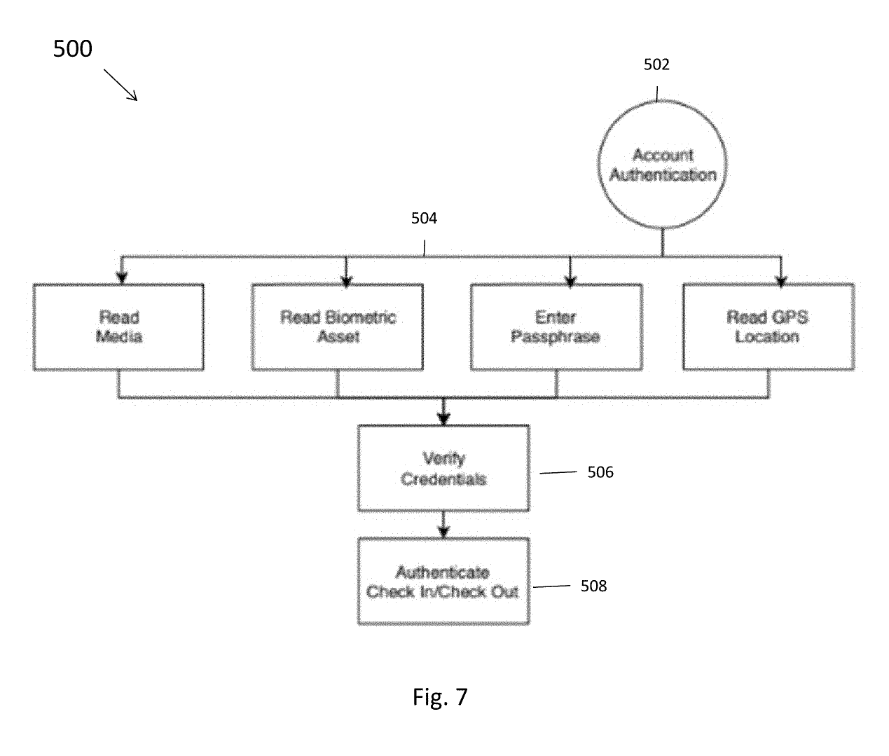

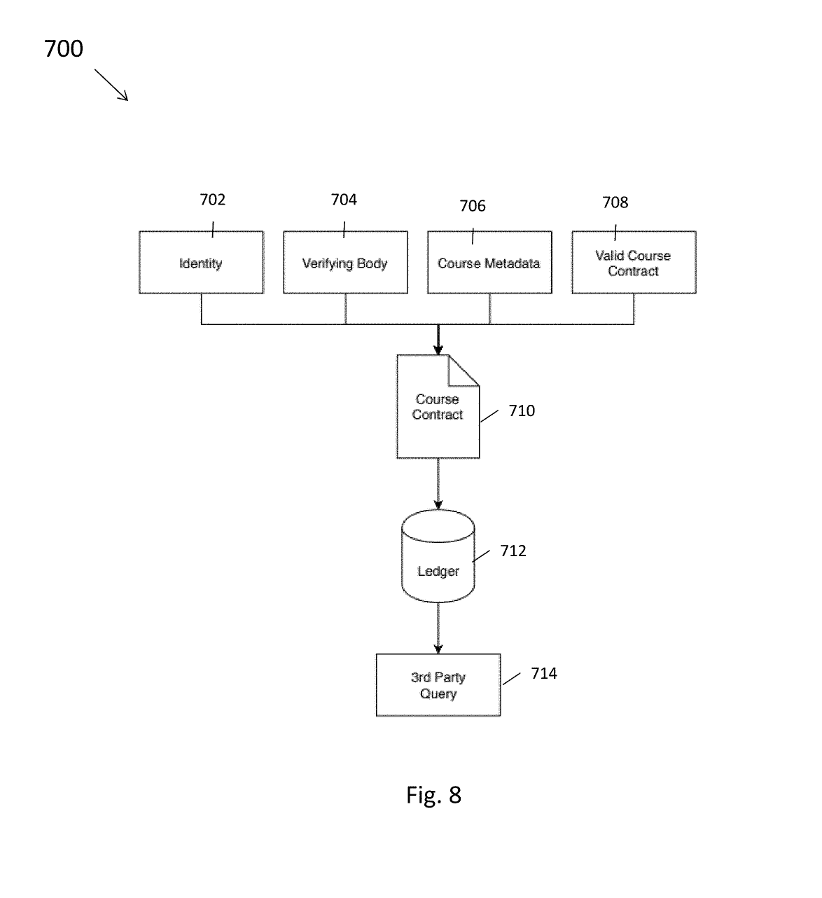

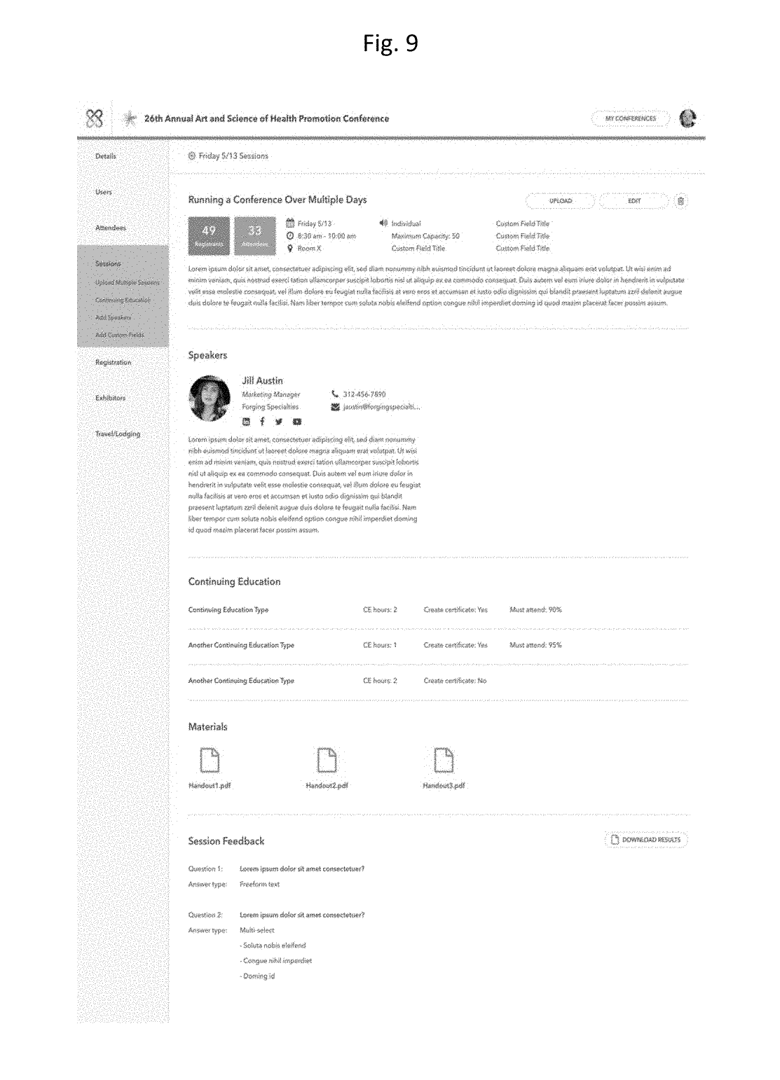

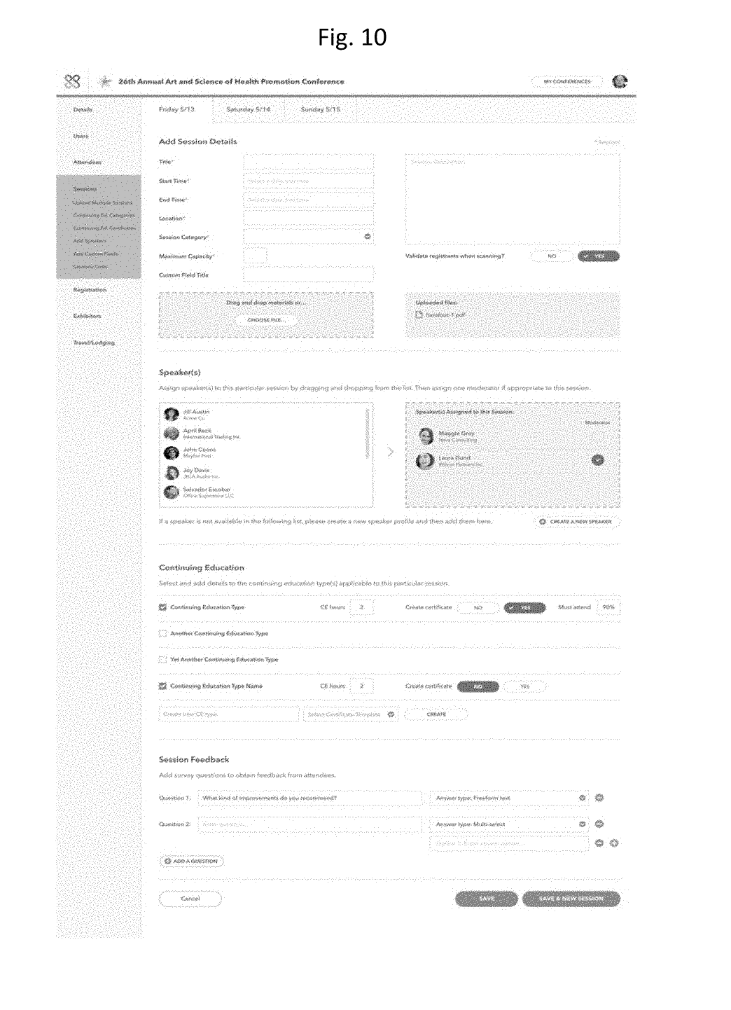

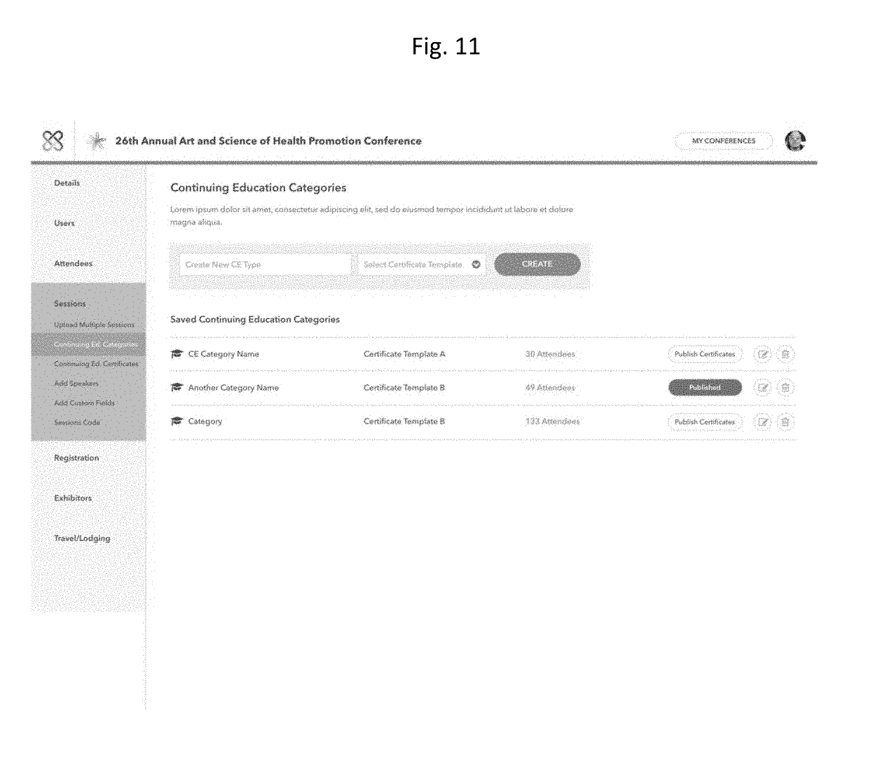

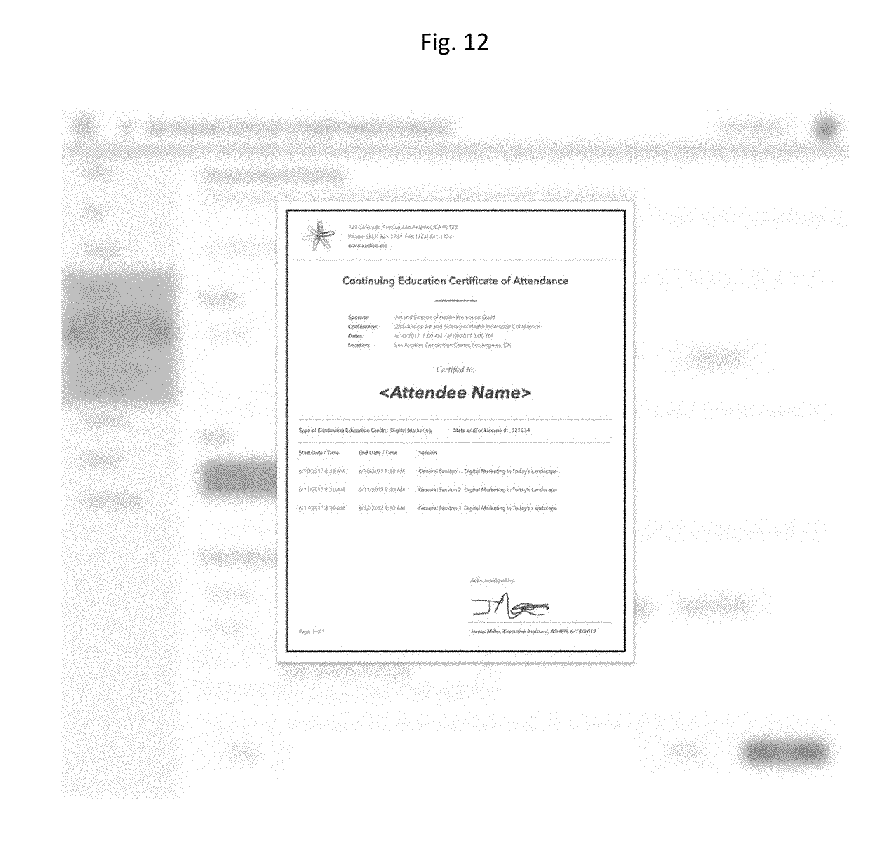

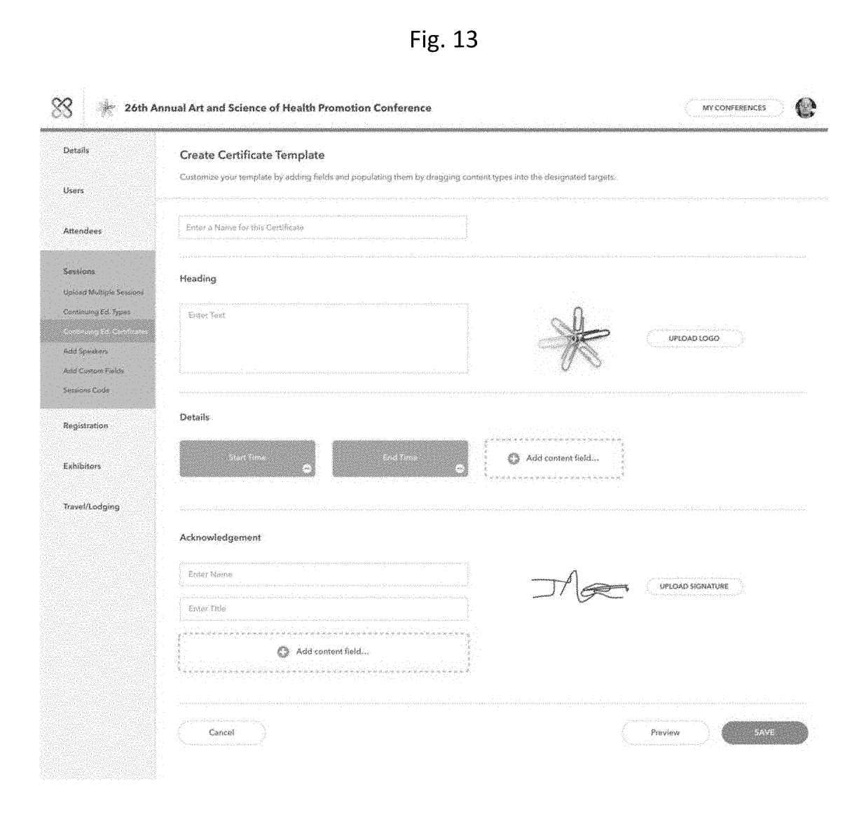

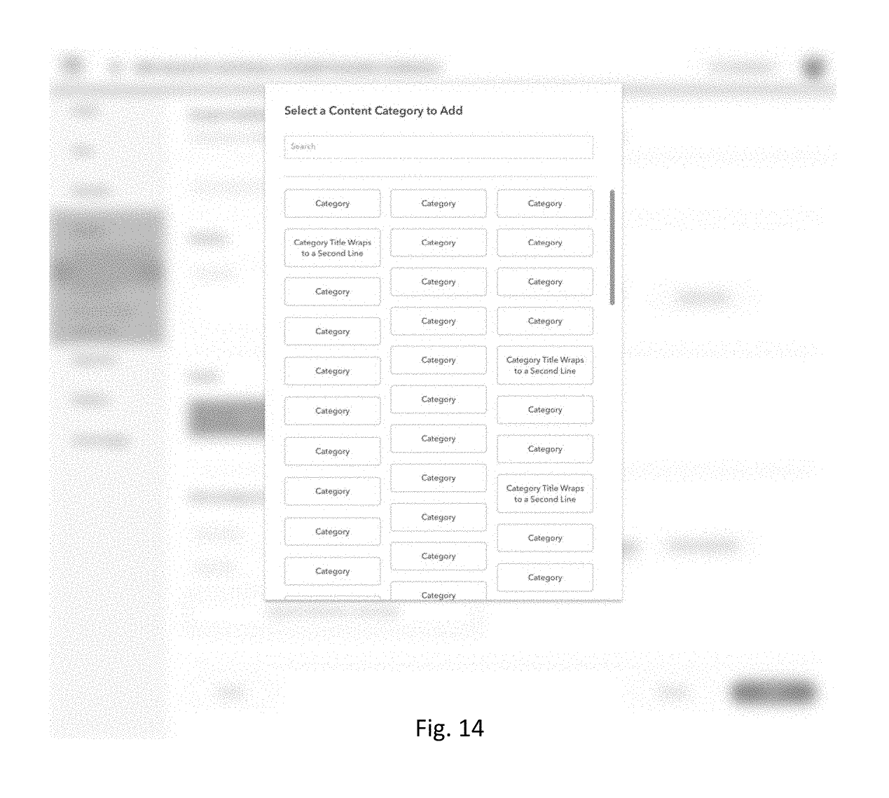

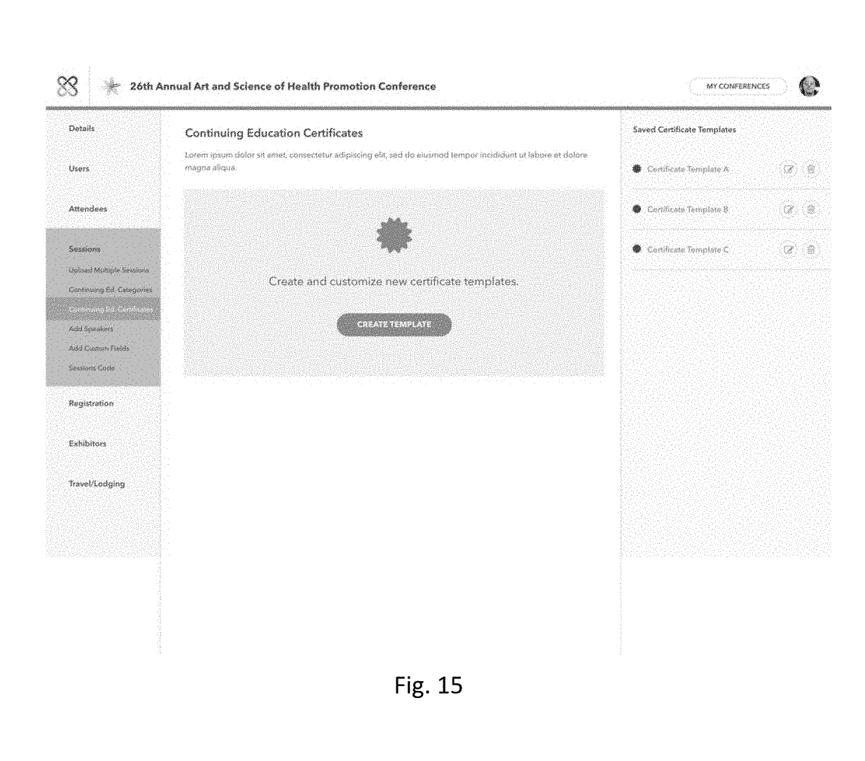

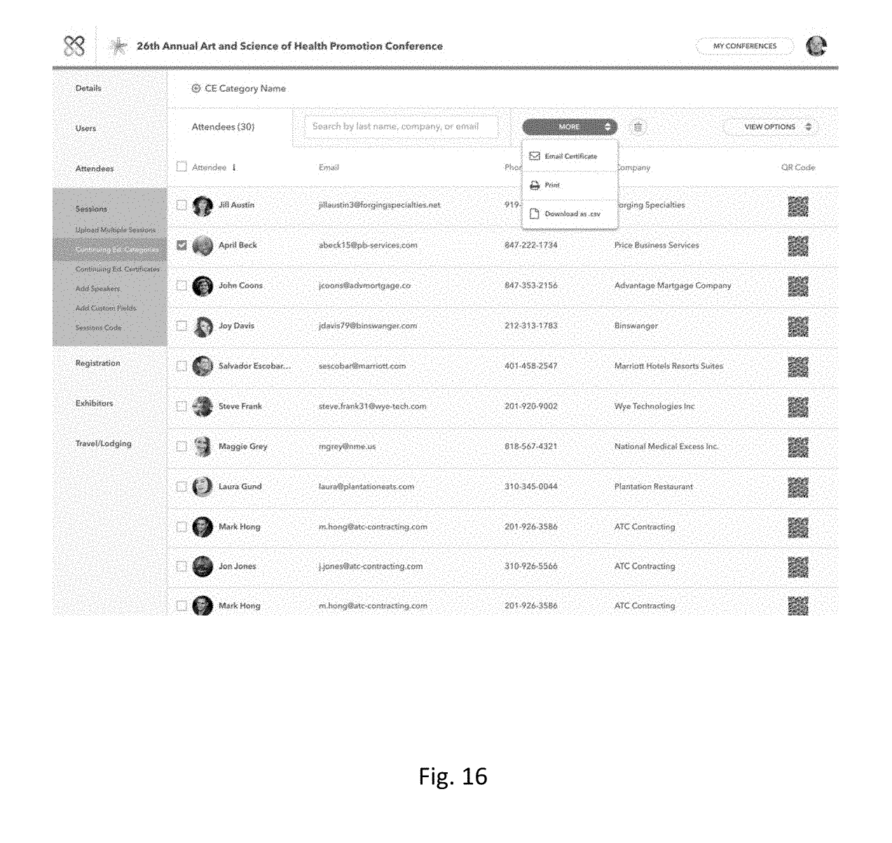

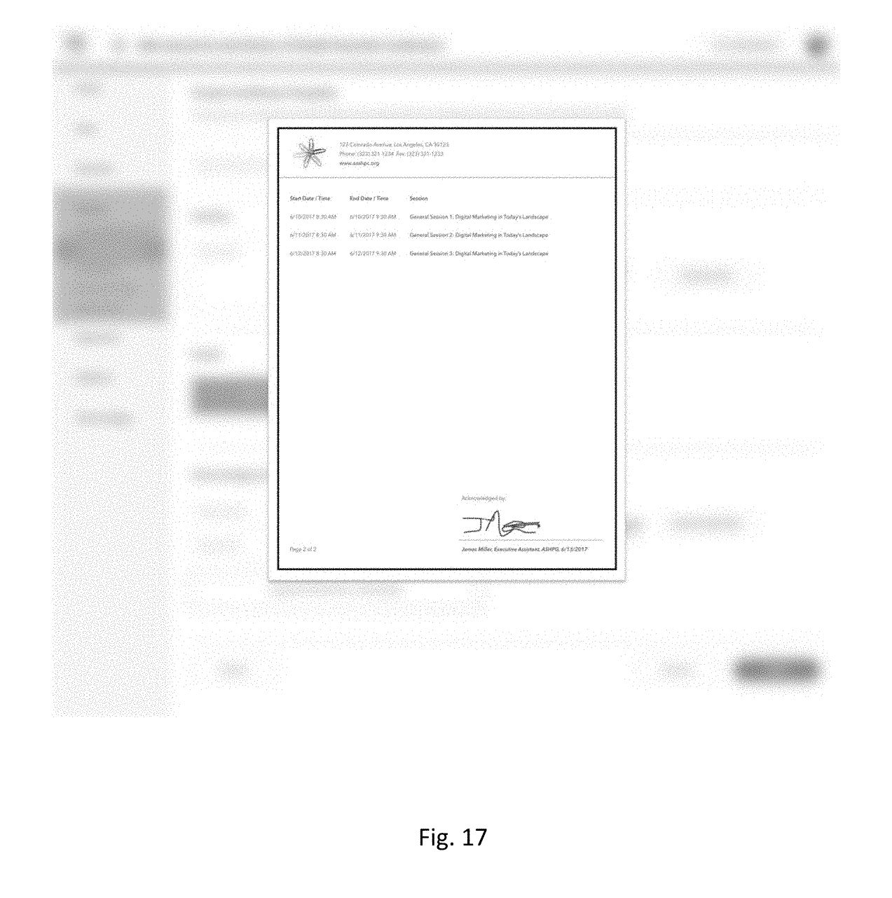

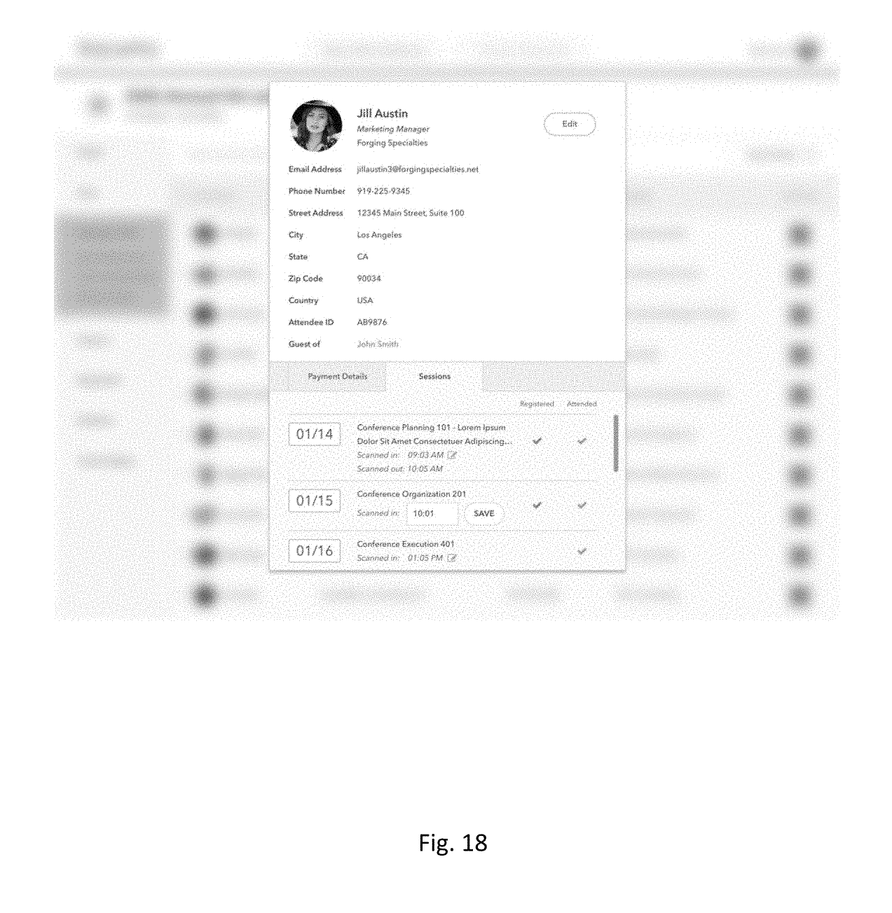

FIGS. 9-18 are illustrations comprising of various screenshots of an example embodiment of the GUI including creation of a continuing education session, assignment of type of continuing education, assigning credit hours, assigning qualifying threshold, tracking attendance and generating certificate of completion for an exemplary application of the automated continuing education attendance and credit tracking system.

The systems and methods of the present invention may be embodied in various forms, including, for example, a data processor, such as the computer that also includes a database. Moreover, the above-noted features and other aspects and principles of the instant disclosure may be implemented in various environments. Such environments and related applications may be specially constructed for performing the various processes and operations of the instant disclosure, or they may include a general-purpose computer or computing platform selectively activated or reconfigured by code to provide the necessary functionality.

Whereas particular aspects of this invention have been described above for purposes of illustration, it will be evident to those skilled in the art that numerous variations of the details of the present invention may be made without departing from the invention.

Network and communication between the various modules may include, alone or in any suitable combination, a telephony-based network, a local area network (LAN), a wide area network (WAN), a dedicated intranet, the Internet or World Wide Web, a wireless network, a bus, or a backplane. Further, any suitable combination of wired and/or wireless components and systems may be incorporated into the network. Moreover, the network may be embodied as bi-directional links or as unidirectional links.

The processes disclosed herein are not inherently related to any particular computer or other apparatus, and may be implemented by a suitable combination of hardware, software, and/or firmware. For example, various general-purpose machines may be used with programs written in accordance with the instant teachings, or it may be more convenient to construct a specialized apparatus or system to perform the required methods and techniques.

Apparatus, systems and methods consistent with the instant disclosure also include computer-readable media (or memory) that include program instructions or code for performing various processing device-implemented operations based on the methods and processes described herein. The media and program instructions may be those specially designed and constructed for the purposes of the instant disclosure, or they may be of the kind well known and available to those having skill in the computer software arts. Examples of program instructions include, for example, machine code, such as produced by a compiler, and files containing a high-level code that can be executed by the computer using an interpreter.

While particular preferred embodiments have been shown and described, it is to be understood that the foregoing description is exemplary and explanatory only and is not restrictive of the instant disclosure. Those skilled in the art will appreciate that changes and additions may be made without departing from the instant teachings. For example, the teachings of the instant disclosure may be directed to various combinations and sub-combinations of the disclosed features and/or combinations and sub-combinations of several further features described herein. It is therefore contemplated that any and all modifications, variations or equivalents of the above-described teachings fall within the scope of the basic underlying principles disclosed above and claimed herein.

1. A continuing education attendance management system comprising:
a backend networked server configured to execute a plurality of continuing education software modules and having a front end graphical user interface accessible by a networked device;
a continuing education management module configured to collect registration data through preset or customizable data entry fields accessible through the graphical user interface and store the registration data in a continuing education management module database, the continuing education management module further configured as a data delivery module for streaming pre-recorded or live continuing education content, and the continuing education management module further configured to qualify a registrant, assign credit hours, assign qualifying threshold, generate a certificate and export certificate to an attendee or regulating body;
an attendance tracking module configured to collect continuing education attendance data through the graphical user interface and store attendance data in an attendance module database; and
wherein each module of the plurality of software modules is communicatively coupled through the backend networked server to share collected data.

2. The continuing education attendance management system of claim 1 wherein the continuing education management module database and attendance module database are sub-databases of a system database.

3. The continuing education attendance management system of claim 2 wherein continuing education management module is further configured to validate membership by cross-checking the registrant profiles with a prepopulated membership database.

4. The continuing education attendance management system of claim 1 wherein the continuing education management module is configured as a payment module configured to collect electronic payment data through the graphical user interface and process the electronic payment data through an electronic payment service provider.

5. The continuing education attendance management system of claim 1 wherein the continuing education management module is further configured to collect presentation schedules, presenter information, venue information and environment information, session recordings and configured to display the collected event data to a registrant through the graphical user interface.

6. The continuing education attendance management system of claim 1 wherein the attendance tracking module is further configured to collect attendance data through a check-in routine whereby the registrant accesses the graphical user interface of the attendance tracking module sets attendance as present or wherein the attendance tracking module is further configured to collect attendance data through a local networked device configured to detect a registrant's unique identifier code upon entrance to the event and set the registrant status as present and validate registrants attendance.

7. The continuing education attendance management system of claim 6 wherein the local networked device comprises a QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan.

8. The continuing education attendance management system of claim 6 wherein the attendance tracking module analyzes the continuing education management module database to verify whether the registrant is seeking credit for attendance from a regulatory agency for continued education and is further configured to electronically notify the regulatory agency for continued education of completion of the course.

9. The continuing education attendance management system of claim 6 wherein the attendance tracking module is further configured to collect attendance data through a check-out routine whereby the registrant accesses the graphical user interface of the attendance tracking module sets attendance as checked-out or wherein the attendance tracking module is further configured to collect attendance data through a local networked device configured to detect a registrant's unique identifier code upon exiting the event and set the registrant status as checked-out and validate registrants attendance.

10. The continuing education attendance management system of claim 9 wherein the local networked device comprises a QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan.

11. The continuing education attendance management system of claim 9 wherein a percentage of course completion is calculated by comparing a check-in time stamp and check-out time stamp, and attendance is validated if the percentage of course completion is above a preset percentage threshold.

12. The continuing education attendance management system of claim 11 wherein the system is configured to generate or publish a completion certificate available through the graphical user interface upon validated attendance meeting the preset percentage threshold.

13. The continuing education attendance management system of claim 9 further comprising a digital fingerprinting module configured to combine predetermined data into a course contract, record the course contract onto a ledger or distributed ledger, and make the ledger or distributed ledger available to search through the graphical user interface.

14. The continuing education attendance management system of claim 1 further comprising a qualitative analysis module configured to analyze session data and course materials with reference to predefined scholarly databases to determine similarity to scholarly database material.

15. A method of tracking continuing education attendance comprising the steps of:
accessing a backend networked server configured to execute a plurality of continuing education management software modules and having a front end graphical user interface accessible by a networked device wherein the plurality of event management software modules a continuing education management module configured to collect registration data through preset or customizable data entry fields accessible through the graphical user interface and store the registration data in a continuing education management module database, the continuing education management module further configured as a data delivery module for streaming pre-recorded or live continuing education content, and the continuing education management module further configured to qualify a registrant, assign credit hours, assign qualifying threshold, generate a certificate and export certificate to an attendee or regulating body, and an attendance tracking module configured to collect lead data through the graphical user interface and store the attendance data in an attendance tracking module database;
activating the attendance tracking module through the graphical user interface of the local networked device;
acquiring a registrant's unique identifier code through the local networked device upon a registrant's entrance to the event;
querying the registration module database for the registrant's unique identifier code and validating a registrant's profile from the registration module database;
setting a registrant's attendance status in the attendance tracking module database;
acquiring a registrant's unique identifier code through the local networked device upon a registrant's exit of the event; and
setting a registrant's attendance status in the attendance tracking module database.

16. The method of claim 15 wherein the local networked device comprises a computer, mobile phone, QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan, preset code or password.

17. The method of claim 15 wherein a percentage of course completion is calculated by comparing a check-in time stamp and check-out time stamp, and attendance is validated if the percentage of course completion is above a preset percentage threshold.

18. The method of claim 17 wherein the system is configured to generate or publish a completion certificate available through the graphical user interface upon validated attendance meeting the preset percentage threshold.

19. The method of claim 18 wherein the system is configured to send a validated completion record to a regulatory body that authorized and verified the session.
